(19) United States
(12) Patent Application Publication
(10) Pub. No.: US 2014/0186250 A1
(43) Pub. Date: Jul. 3, 2014

(54) CARBONYL FUNCTIONALIZED POROUS INORGANIC OXIDE ADSORBENTS AND METHODS OF MAKING AND USING THE SAME

(71) Applicants: M. Douglas LEVAN, Brentwood, TN (US); Amanda M.B. FURTADO, Clarksville, TN (US); Yu WANG, Lebanon, NJ (US); Gregory W. PETERSON, Belcamp, MD (US)

(72) Inventors: M. Douglas LEVAN, Brentwood, TN (US); Amanda M.B. FURTADO, Clarksville, TN (US); Yu WANG, Lebanon, NJ (US); Gregory W. PETERSON, Belcamp, MD (US)

(73) Assignees: THE UNITED STATES OF AMERICA, Washington, DC (US); VANDERBILT UNIVERSITY, Nashville, TN (US)

(21) Appl. No.: 13/553,272

(22) Filed: Jul. 19, 2012

(51) Int. Cl. B01D 53/50; B01D 53/58

(52) U.S. Cl. CPC B01D 53/508; B01D 53/58
USPC 423/237; 423/210; 423/242.2; 556/9

(57) ABSTRACT

An adsorbent material comprising a porous inorganic oxide material grafted with a molecule comprising a carbonyl functional group is provided. The porous inorganic oxide material can be a porous silica material or Zr(OH)₄. The adsorbent material can be a synthesized by grafting an organosilane molecule containing the carbonyl functional group onto the porous inorganic oxide material. The porous inorganic oxide material can be grafted with a second molecule comprising an amine functional group. Methods of making the adsorbent material and methods of removing molecules from a fluid using the adsorbent material are also provided.

### STATEMENT REGARDING FEDERALLY SPONSORED RESEARCH

This invention was made with government support under RDECOM #W911SR-08-C-0028, awarded by United States Army Edgewood Chemical and Biological Center. The government has certain rights in the invention.

### BACKGROUND

1. Field

The present invention relates to adsorbent materials in general and, in particular, to adsorbent materials comprising a porous silica material grafted with a molecule comprising at least one carbonyl functional group.

2. Background of the Technology

Nanoporous adsorbent materials have attracted attention due to their numerous potential applications, which range from catalysis to energy storage and environmental protection. [1-4] The removal of light gases from air is of extreme interest in the United States today, since adsorbents that accomplish this have applications in a wide array of industries, including building filtration and for protection of military personnel and civilians. In particular, adsorbents for use in respirators and for protection against chemical threats should have high single-pass capacities for low concentrations of gases in air. These adsorbents should also provide activity against a broad spectrum of gases, since the exact nature of chemical threats are not known prior to an event.

Structured mesoporous silica materials, such as members of the M41S family, and metal oxide materials are prime candidates for use as respirator adsorbents. These materials often have high surface areas and regularly repeating structures. These materials also often have intrinsic capacity for some light gases. Members of the M41S family are formed via a liquid crystal templating method with ionic surfactants as structure directing agents. [1, 5] The mesoporous materials are formed by condensing the silica onto the surfactant liquid crystals and then removing the surfactant from the final product.[6] The high surface areas and regularly repeating structures allow for post synthetic modifications to tailor the adsorption capacity to specific types of molecules. For example, the ordered mesoporous silica material MCM-41 has a high ammonia capacity, and zirconium hydroxide has a high sulfur dioxide capacity. The versatility of these materials has resulted in commercial production of some oxides. In 2008, Taiyo Kagaku Company Ltd. opened a mesoporous silica production plant in Japan to make mesoporous silica materials commercially available. MEL Chemicals is a UK company with production and global distribution of commercial quantities of zirconium hydroxide. The regularly repeating Si—O—Si or Metal-O-Metal bonds allow for post synthetic modification using silane chemistry to graft different molecules to the surface of the materials, and thus to tailor the adsorption capacities to light gases. [7-9]

There are two general routes available for surface modification of structured silicas with functional groups. In co-condensation, also known as one-pot synthesis, silane molecules containing the functional group of interest are included in the gel during synthesis. In this method, the surfactant must be removed from the pores using solvent extraction rather than calcination, since high temperatures would result in destruction of the functional groups. The resulting siliceous materials have different pore structures and morphology than the corresponding mesoporous material made without the organoalkoxysilane. [10, 11] In the post-synthetic grafting route, hydroxyl groups on the synthesized mesoporous silica are functionalized with silane molecules containing the functional group of interest. Distribution of grafted molecules is not as uniform as the co-condensation route; [12-14] however the grafted mesoporous silicas remain ordered when grafting at higher concentrations, whereas attempting co-condensation at high alkoxysilane concentrations generally results in a breakdown in mesoporous silica structure. [11, 13] One common method of post-synthetic functionalization involves treating calcined mesoporous silicas with functional organoalkoxysilanes. [9, 15-20] The silanol groups on the mesoporous silicas are used to covalently bond the organosilane [21] in the presence of solvent, thereby resulting in a functionalized mesoporous silica that retains its native structure.

Amine modification has become a popular area of interest since carbon dioxide storage and capture has become a prime light gas target for adsorbent material design. [18] Post synthetic grafting of amine molecules on siliceous materials results in bifunctional materials [22] that have chemisorption potential for a wide range of light gases. [18, 23-25] It has been previously shown [26-29] that due to the hydroxyl groups on MCM-41, the material exhibits a high capacity for basic gases such as ammonia.

There still exists a need for improved adsorbent materials for light gas removal.

### SUMMARY

An adsorbent material is provided which comprises:

a porous inorganic oxide material; and

a first molecule grafted to the porous inorganic oxide material;

wherein the first molecule comprises at least one carbonyl group.

A method is provided which comprises:

contacting a porous inorganic oxide material with a first molecule comprising an alkoxysilane functional group and a carbonyl functional group;

allowing the alkoxysilane functional group to react with hydroxyl groups on the surface of the porous inorganic oxide material such that the first molecule is covalently attached to the porous inorganic oxide material.

A method of removing molecules from a fluid containing the molecules is also provided which comprises:

contacting the fluid with an adsorbent material as set forth above to allow the adsorbent material to adsorb the molecules from the fluid

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIGS. 1A-1D show the chemical formulae of exemplary organoalkoxysilanes which can be grafted onto porous inorganic oxide materials.

FIG. 2 is a schematic showing a silane grafting reaction.

FIG. 3 is a schematic showing an apparatus which can be used to determine ammonia capacities of adsorbent materials.

FIG. 4 is a graph showing Nitrogen isotherms for MCM-41 and for MCM-41 grafted with molecules containing various functional groups.

FIG. 5 is a graph showing x-ray diffraction patterns for MCM-41 and for MCM-41 grafted with molecules containing various functional groups.

FIG. 6 is a schematic showing a reaction scheme for ammonia and carbonyl groups.

FIG. 7 is a bar chart showing ammonia chemisorption on methacryloxypropyl-trimethoxysilane (MAPS) grafted MCM-41 (MAPS-MCM-41).

FIG. 8 is a bar chart showing sulfur dioxide chemisorption on 3-aminopropyltriethoxy silane (APTES) grafted MCM-41 (APTES-MCM-41).

### DESCRIPTION OF THE VARIOUS EMBODIMENTS

The present invention is more particularly described in the following examples that are intended as illustrative only since numerous modifications and variations therein will be apparent to those skilled in the art. Various embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which has no influence on the scope of the invention. Additionally, some terms used in this specification are more specifically defined below.

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing various embodiments of the invention and how to practice the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, if any, the term “scanning electron microscope (SEM)” refers to a type of electron microscope that images the sample surface by scanning it with a high-energy beam of electrons in a raster scan pattern. The electrons interact with the atoms that make up the sample producing signals that contain information about the sample's surface topography, composition and other properties such as electrical conductivity.

As used herein, if any, the term “X-ray diffraction (XRD)” refers to a method of determining the arrangement of atoms within a crystal or solid, in which a beam of X-rays strikes a crystal and diffracts into many specific directions. From the angles and intensities of these diffracted beams, a crystallographer can produce a three-dimensional picture of the density of electrons within the crystal. From this electron density, the mean positions of the atoms in the crystal can be determined, as well as their chemical bonds, their disorder and various other information. In an X-ray diffraction measurement, a crystal or solid sample is mounted on a goniometer and gradually rotated while being bombarded with X-rays, producing a diffraction pattern of regularly spaced spots known as reflections. The two-dimensional images taken at different rotations are converted into a three-dimensional model of the density of electrons within the crystal using the mathematical method of Fourier transforms, combined with chemical data known for the sample.

The present invention, in one aspect, relates to a composite adsorbent material useful for removing contaminant molecules from fluids, including toxic light gases from air. The adsorbent material comprises a porous phase comprising an inorganic oxide grafted with a molecule comprising a carbonyl group. According to some embodiments, the grafted molecule phase comprises molecules with silicon-oxygen bonds that can participate in silane chemistry to attach to the inorganic oxide phase. The grafted molecule may also comprise one or more amine groups. According to some embodiments, a porous material comprising an inorganic oxide can be grafted with a first molecule comprising a carbonyl group and a second molecule comprising one or more amine groups. The addition of amine and carbonyl sites to the porous material provides the material with the ability to chemisorb both acidic and basic gases.

The porous inorganic oxide material can be zirconium hydroxide or a porous silica material such as an ordered mesoporous silica (OMS). The porous inorganic oxide material provides the adsorbent with enhanced stability, including the ability to be conditioned at high temperatures and relative humidities.

According to some embodiments, the porous material comprises: at least one ordered mesoporous silica material selected from the group consisting of SBA-15, MCM-48 and MCM-41; zirconium hydroxide; fumed silica; silicalite zeolites; molecular sieves; silica gels; and combinations thereof.

In another aspect, the present invention relates to a method of synthesizing an adsorbent material. According to some embodiments, the method comprises: contacting a porous material comprising an inorganic oxide with a first molecule comprising an alkoxysilane functional group and a carbonyl functional group; allowing the alkoxysilane functional group to react with hydroxyl groups on the surface of the porous material such that the first molecule is covalently attached to the porous material.

In yet another aspect, the present invention relates to an adsorbent made from the method as set forth above.

In a further aspect, the present invention relates to a method of removing molecules from a fluid containing the molecules. According to some embodiments, the method comprises contacting an adsorbent material as set forth above with the fluid to allow the adsorbent to adsorb the molecules from the fluid.

The fluid can be in a form of gas, or liquid. According to some embodiments, the molecules are contaminant molecules.

According to some embodiments, the fluid is air (e.g., humid air) and the molecules are from toxic light gases mixed with said air. According to some embodiments, the toxic light gases comprise industrial chemicals and/or chemical warfare agents.

### Experimental

The practice of this invention can be further understood by reference to the following examples, which are provided by way of illustration only are not intended to be limiting.

A porous silica material (MCM-41) was grafted with different organoalkoxysilane molecules which contribute carbonyl and amine functional groups to enhance the removal of ammonia and sulfur dioxide from air. Ammonia is used as a representative basic molecule and sulfur dioxide is used as an acidic molecule to optimize the interactions between the bifunctional adsorbent and light gases.

### Experimental Methods

### Materials

Tetramethylammonium hydroxide pentahydrate, TMAO (97%), tetramethylammonium silicate solution, TMASi (99.99%, 15-20 wt % in water), and sulfuric acid (95.0-98.0%) were purchased from Sigma-Aldrich. Hexadecyltrimethylammonium chloride, CTAC (25%) in water was purchased from Pfaltz and Bauer. A solution of ammonium hydroxide (29 wt %) in water, Cab-O—Sil M5, and 5 mL of nitrogen_ushed 3-(aminopropyl)triethoxysilane (APTES) were purchased from Fisher Scientific. Methacryloxpropyl-trimethoxysilane (MAPS, 98%), 3-(triethoxysilyl)propyl isocyanate (isocyanate, 95%), and 3-(trimethoxysilyl)propyl urea (urea, 97%) were purchased from Sigma Aldrich.

### MCM-41 Synthesis

Hexagonally-ordered MCM-41 with a 37 Å pore was synthesized according to the procedure detailed in a previous study.26 The as-synthesized material was calcined by heating in air from room temperature to 540_C at 1_C/min and holding at 540_C for 10 hours.

### Organoalkoxysilane Grafting

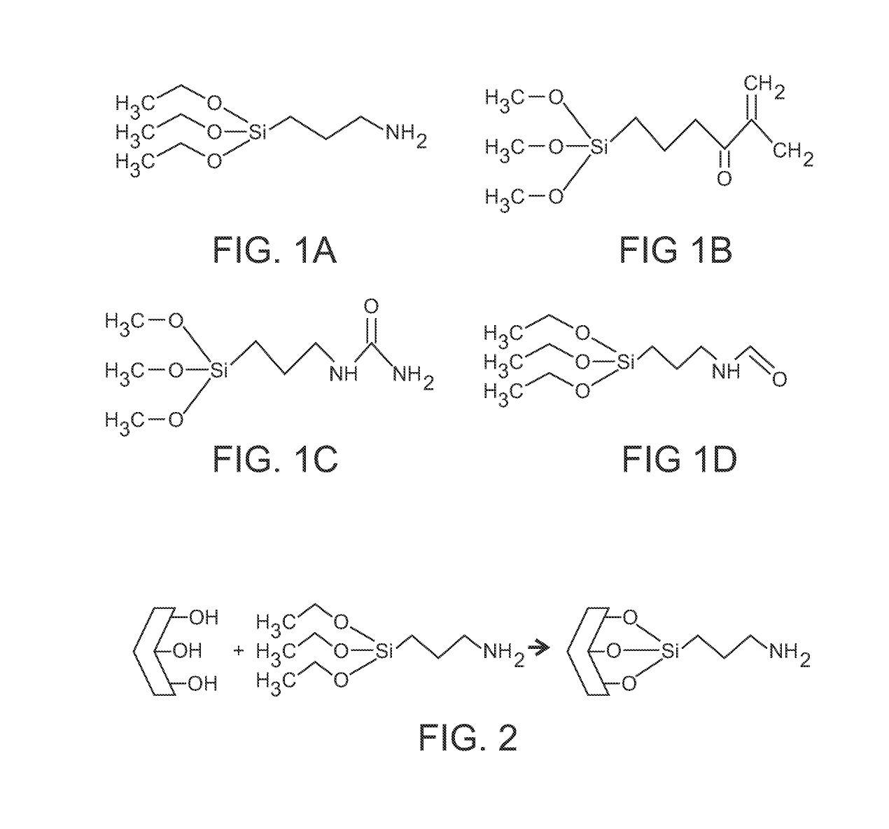

Organoalkoxysilanes were chosen for grafting based on their functional groups. For ammonia removal, molecules were chosen with carbonyl groups. For sulfur dioxide removal, molecules with amine groups were chosen. FIG. 1 summarizes the molecular structure of the organoalkoxysilanes chosen. Table 1 summarizes the number of carbonyl and amine groups present in each molecule.

TABLE 1
Summary of Molecules Used for Grafting onto MCM-41
and Experimental Conditions for Grafting

| | Molec. | | Carbonyl | Amine |
|---|---|---|---|---|
| Grafted Molecule | Amt. | Wt % in | groups/ | groups/ |
| (Abbreviation) | (mL) | sample | molecule | molecule |
| 3-aminopropyltriethoxysilane | 0.48 | 31 | 0 | 1 |
| (APTES) | | | | |
| 3-trimethoxysilylpropyl urea | 0.193 | 18 | 1 | 2 |
| (urea) | | | | |
| 3-trimethoxysilylpropyl urea | 0.39 | 31 | 1 | 2 |
| (urea2x) | | | | |
| 3-triethoxysilylpropyl | 0.5 | 33 | 1 | 1 |
| isocyanate (isocyanate) | | | | |
| Methacryloxypropyl- | 0.24 | 20 | 1 | 0 |
| trimethoxysilane | | | | |
| (MAPS) | | | | |

In Table 1, all molecule amounts correspond to 1 g of MCM-41.

The reaction mechanism for grafting the alkoxysilanes onto MCM-41 is summarized in FIG. 2 which summarizes the general reaction that occurs during the grafting step. Grafting involves mixing the inorganic oxides with the silane molecules under an inert environment in a Schlenk flask (or some other vessel that allows for the exclusion of water). The inorganic oxides and a solvent (such as ethanol, methanol, toluene, acetone, etc.) are added to the vessel, which is then flushed with dry nitrogen for 15 minutes with stirring. Various amounts of silane molecule is then added to the mixture, and the sample is stirred at room temperature overnight under an inert environment and then recovered via filtration. The silane chemistry is similar for all grafted molecules.

The calcined MCM-41 was grafted with the organoalkoxysilanes under an inert environment in a 250 mL Schlenk flask. Calcined MCM-41 and 125 mL of ethanol were added to the flask, which was then flushed with dry nitrogen for 15 minutes while stirring. An amount of organoalkoxysilane was added corresponding to the samples summarized in Table 1. The sample was stirred at room temperature overnight under an inert environment, and then recovered via vacuum filtration. The filtered sample was washed with deionized water to remove excess solvent and air-dried overnight.

All samples summarized in Table 1 have 2 mmoles of functional groups/g MCM-41. Two urea-MCM-41 samples were produced. Urea-MCM-41 has 2 mmol amine groups/g MCM-41 and 1 mmol carbonyl groups/g MCM-41, and urea2x-MCM-41 has 2 mmol carbonyl groups/g MCM-41 and 4 mmol amine groups/g MCM-41. An additional sample was synthesized using a double impregnation technique to graft 2 mmol/g APTES and 2 mmol/g isocyanate onto MCM-41. In this instance, 0.5 mL isocyanate was _rst grafted onto MCM-41 following the previously detailed procedure. After recovering this sample, it was then grafted with 0.48 mL of APTES to produce the APTES-isocyanate-MCM-41.

### Materials Characterization

### Textural Characterization

Adsorption isotherms were performed on a Micromeritics ASAP 2020 at −196_C using nitrogen as the analysis gas. Prior to measurement, approximately 0.1 g of each sample was degassed with heating to 50° C. and vacuum to 10 μbar. After reaching 10 μbar, the samples were heated to 70° C. with vacuum for an additional 6 hours.

### X-Ray Diffraction (XRD)

XRD spectra were used to confirm the long range structure of the native and impregnated MCM-41 samples. The spectra were measured using a Scintag X 1 h/h automated powder diffractometer with Cu target, a Peltier-cooled solid-state detector, a zero background Si(5 1 0) support, and with a copper X-ray tube as the radiation source. Spectra were collected from 1.2 to 7 degrees two-theta using a step size of 0.02 degrees.

### Light Gas Capacity Measurement

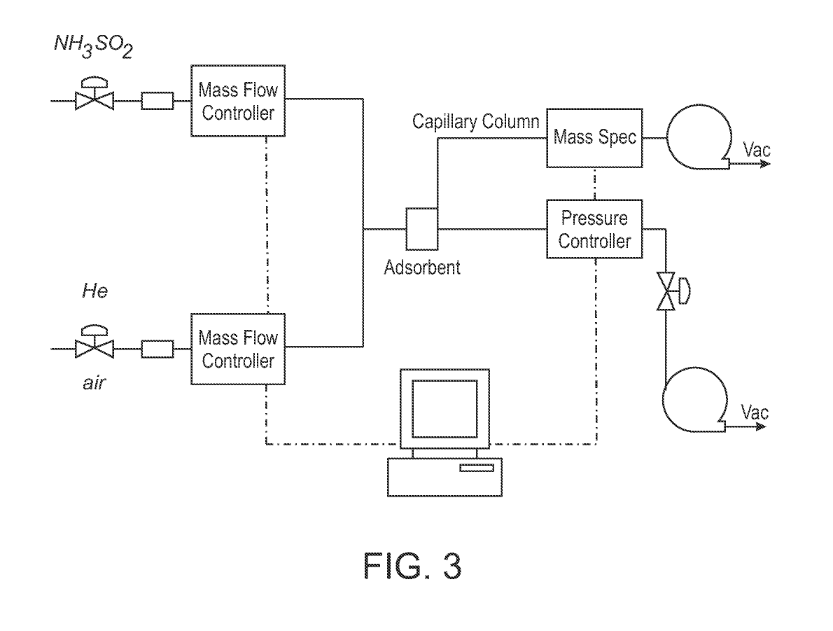

Equilibrium capacities for room temperature light gas adsorption were measured for all samples using a breakthrough apparatus, a schematic of which is shown in FIG. 3. Prior to analysis, all samples were regenerated under vacuum at 60° C. for 2 hours.

For stability reasons, ammonia breakthrough tests were conducted using ammonia in helium. The concentration of ammonia in dry helium fed to the adsorbent bed was kept constant at 1133 mg/m³ (1500 ppmv). Before analysis, regenerated samples were equilibrated for 1 hour in 10 sccm helium. Pre-mixed sulfur dioxide in air was used for SO₂ breakthrough testing to determine whether oxygen or humidity affects the samples. The concentration of sulfur dioxide in dry air was kept constant at 1428 mg/m³ (500 ppmv). The samples tested under humid conditions were equilibrated in 10 sccm air at 70% RH for 1 hour before testing. Samples tested under dry conditions were equilibrated in 10 sccm dry helium for 1 hour prior to analysis.

The capacity of the adsorbent material, n (mol ammonia/kg adsorbent), was calculated from

$$n = \frac{F}{m} {\int }_{0}^{∞} ( {c}_{0} - c ) d t$$

where c₀ is the feed concentration in units of mol/m³, and c is the effluent concentration at time t. The volumetric flow rate of gas through the adsorbent bed, F, was adjusted to yield a breakthrough time of approximately one hour. The mass of the sample, m, was approximately 10 mg and was contained in a small cylindrical adsorbent bed with an internal diameter of 4 mm.

To test for chemisorption, select samples were _rst analyzed for ammonia or sulfur dioxide capacity, purged with helium or air for 10 minutes using a 10 sccm flow rate, then re-tested for ammonia or sulfur dioxide capacity.

### Results and Discussion

### Material Characterization

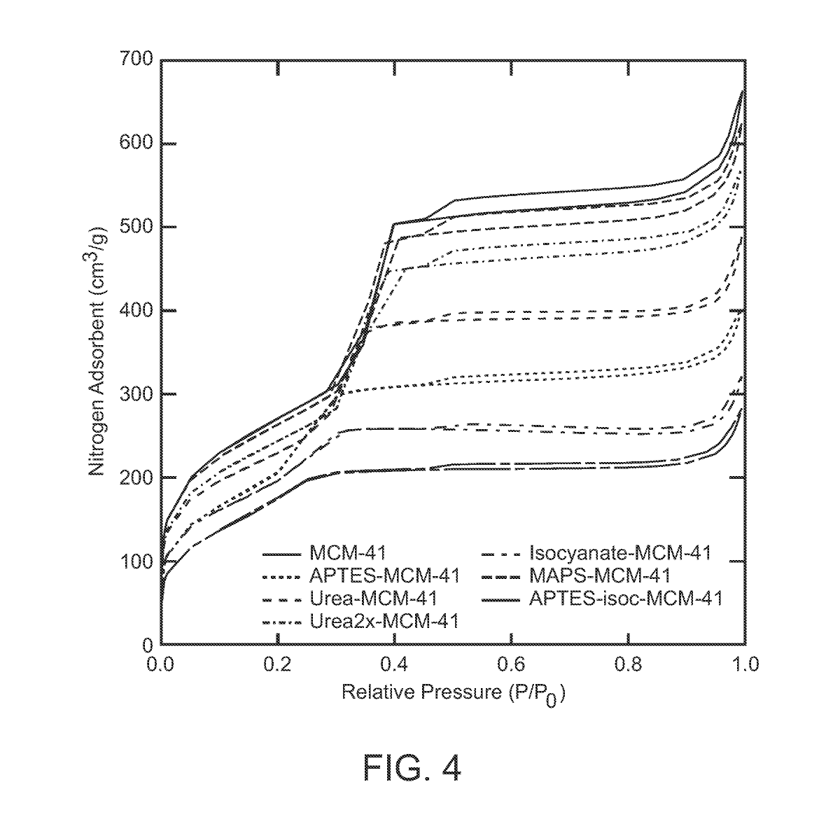

FIG. 4 summarizes nitrogen isotherms for the parent and grafted MCM-41 materials. Similar to the parent isotherm, all grafted samples exhibit type IV isotherms indicative of mesoporous materials. The hysteresis loops represent capillary condensation in the mesopores. Table 2 compares surface areas, pore volumes, and the DFT pore size distribution of the materials.

TABLE 2
BET Surface Areas, Pore Volumes, and DFT
Pore Sizes of MCM-41 and Grafted Samples

| | | | DFT Pore Size, |
|---|---|---|---|
| Sample | BET SA (m²/g) | Vₚₒᵣₑ (cm³/g) | Ang. |
| MCM-41 | 952 | 1.03 | 13, 34 |
| APTES-MCM-41 | 711 | 0.62 | 30, 33 |
| Urea-MCM-41 | 856 | 0.88 | 37, 41 |
| Urea2x-MCM-41 | 805 | 0.76 | 34, 37 |
| Isocyanate-MCM-41 | 681 | 0.5 | 18, 26, 30 |
| MAPS-MCM-41 | 925 | 0.96 | 12, 38, 41 |
| APTES-isoc-MCM-41 | 603 | 0.44 | 23, 26, 30 |

Organoalkoxysilane grafting results in a decrease in surface area compared to the parent material. The decrease in surface area corresponds to a decrease in pore volume and a reduction in pore size when compared to the parent material. This is consistent with grafting a large molecule within the pores of an ordered MCM-41 material. The APTESisocyanate-MCM-41 has undergone two grafting steps, and the surface area and pore volume of this material is less than the other materials, which is consistent with a reduction in surface area with each grafting step.

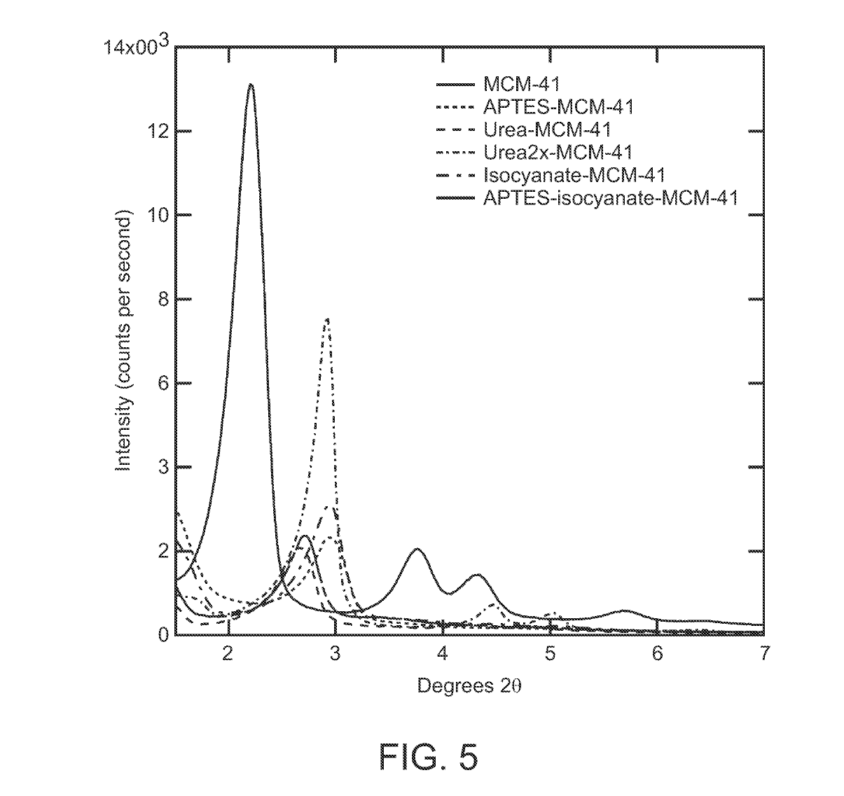

FIG. 5 compares the X-ray diffraction patterns for the parent and grafted materials. According to the XRD spectrum, parent MCM-41 is highly ordered due to the 5 peaks characteristic of the hexagonally ordered MCM-41 structure.26 XRD spectra of the grafted samples show that the corresponding MCM-41 peaks are intact, but shifted to larger angles. This is due to a contraction in the unit cell after grafting the organoalkoxysilanes onto the hexagonally ordered MCM-41. [30]

### Ammonia Adsorption

Table 3 compares the ammonia capacities of the parent MCM-41 to the organoalkoxysilane grafted samples.

TABLE 3
Ammonia Capacities for All Samples in Order
of Increasing Carbonyl Groups

| | mmol | mmol | NH₃ | NH₃ |
|---|---|---|---|---|
| | carbonyl | amine | Capacity | Capacity |
| | groups/g | groups/g | (mol/kg | (mol/kg |
| Sample | MCM-41 | MCM-41 | sample) | MCM-41) |
| MCM-41 | 0 | 0 | 2.00 | 2.00 |
| APTES-MCM-41 | 0 | 2 | 1.34 | 1.95 |
| Urea-MCM-41 | 1 | 2 | 4.93 | 6.02 |
| Urea2x-MCM-41 | 2 | 4 | 9.37 | 13.6 |
| APTES-isoc-MCM-41 | 2 | 4 | 5.90 | 11.5 |
| Isocyanate-MCM-41 | 2 | 2 | 13.9 | 20.8 |
| MAPS-MCM-41 | 2 | 0 | 24.1 | 30.1 |

The samples in this table are listed in order of increasing carbonyl content, since the purpose of including the carbonyl functional group is to enhance ammonia capacity.

As mentioned previously, [26] the parent MCM-41 exhibits an ammonia capacity of 2 moles ammonia/kg sample. In grafted samples without carbonyl groups (the material grafted with APTES), the presence of amine groups decreases the ammonia capacity over that of parent MCM-41, 1.34 mol/kg compared to 2 mol/kg. This decrease in capacity is a result of calculating capacity per kg sample rather than per kg MCM-41. The parent MCM-41 has a capacity of 2 mol/kg sample, but that sample consists of 100% MCM-41. After grafting large molecules onto the MCM-41, the capacity is still reported in mol NH₃/kg sample, however the sample includes a mass of grafted molecules in addition to the MCM-41. The last column in Table 3 shows the ammonia capacity for the samples with units of mol NH₃/kg MCM-41. A comparison of the ammonia capacities of APTESMCM-41 and parent MCM-41 are within experimental error (1.95 mol/kg compared to 2.00 mol/kg). Consequently, grafting amine groups onto the siliceous support does not decrease the ammonia capacity compared to that of the parent.

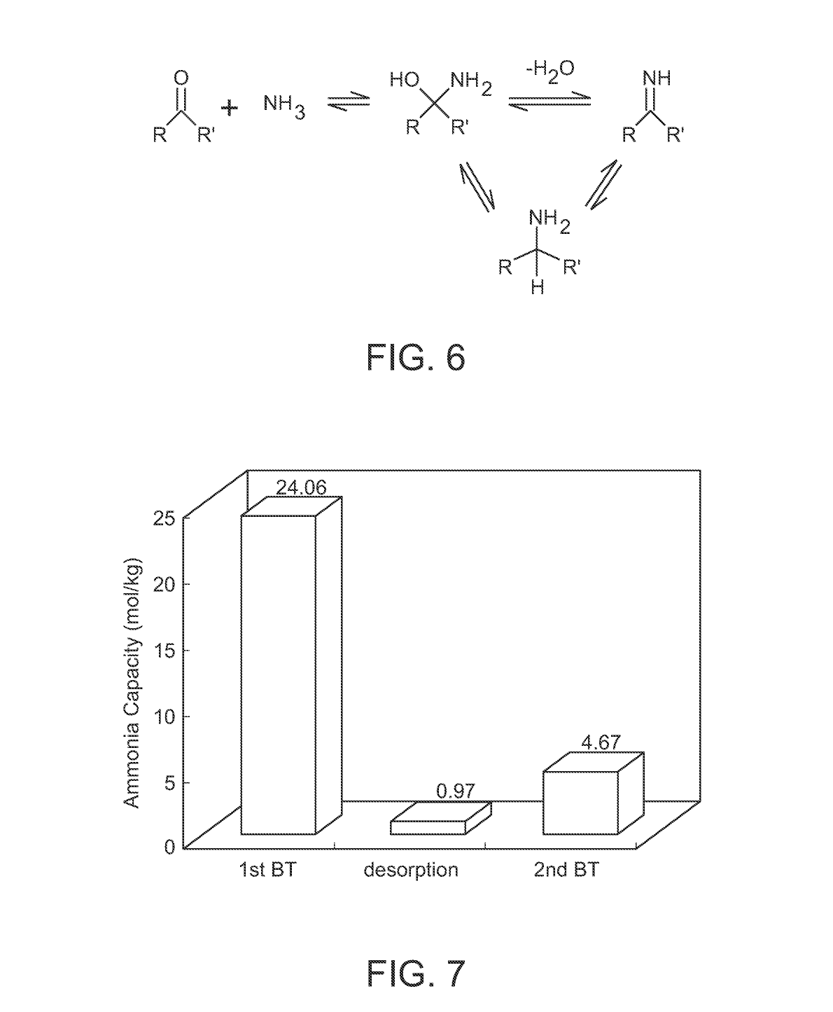

In general, the presence of carbonyl groups within the grafted molecule of interest does enhance the ammonia capacity. Two urea-MCM-41 samples were prepared, corresponding to 1 and 2 mmol carbonyl groups/g MCM-41. The urea-MCM-41 sample with twice the amount of urea molecules grafted onto MCM-41 has an approximately double ammonia capacity of the 1 mmol/g urea-MCM-41 sample. This is indicative of the nucleophilic nitrogen in ammonia molecules reacting with the electrophilic carbon in the carbonyl group, as shown in the reaction detailed in FIG. 6. [32] The formation of the hemiaminal intermediate provides an additional hydroxyl group which could interact with ammonia and boost the chemisorption potential of the material similar to the interactions of ammonia with the hydroxyl groups on the silica substrate.

The isocyanate-MCM-41 and MAPS-MCM-41 samples have larger capacities (13.9 mol/kg and 24.1 mol/kg) compared to the urea grafted materials. This could be a result of both isocyanate and MAPS having fewer amine groups in the grafted molecules. The urea has two amine groups per molecule, isocyanate has one, and MAPS has no amine groups. In the urea molecule, the amine groups are on either side of the electrophilic carbon, which could redistribute the electrons around the carbon in the carbonyl group differently than that of a carbonyl group with no neighboring amines. This redistribution of electrons could cause shielding of the carbonyl groups from fully reacting with the ammonia molecules, thereby decreasing the efficiency of chemisorption. The isocyanate molecule has the carbonyl at the end of the chain molecule, consequently it is readily available for reaction with ammonia. However, it does have one amine group attached to the carbonyl carbon, and this reduces the reactivity of the carbonyl group compared to MAPS. The carbonyl group in MAPS dominates the molecule since there are no amine groups to shield the chemisorption reaction. The ammonia capacities of these grafted materials decrease with increasing number of amine groups; MAPS-MCM-41 has the highest capacity, then isocyanate-MCM-41, urea2x-MCM-41, urea-MCM-41, and finally, APTES-MCM-41. Thus, the presence of amine groups on the grafted molecule shield the carbonyl functional groups from fully reacting with ammonia.

The doubly-grafted APTES-isocyanate-MCM-41 has a lower ammonia capacity than isocyanate-MCM-41 but a higher ammonia capacity than APTES-MCM-41. Similar to the urea-grafted samples, the amine groups in the grafted APTES molecules could shield the carbonyl groups from reacting as efficiently with ammonia. They could also be reacting with carbonyl groups in the grafted isocyanate molecules and thus reduce the ammonia capacity. Based on the analysis of this sample's sulfur dioxide capacity in the following section, the shielding effect is most likely the reason for the decrease in ammonia capacity compared to isocyanate-MCM-41. However, some of the carbonyl groups are exposed enough to react with ammonia since the ammonia capacity is much higher than that of the parent or APTES grafted MCM-41. Consequently, by grafting different molecules onto the siliceous support, it is possible to tailor the ammonia capacity of the samples.

### Sulfur Dioxide Adsorption

Table 4 compares the sulfur dioxide capacities of all grafted samples.

TABLE 4
Sulfur Dioxide Capacities Of All Samples In Order Of Increasing Amine Groups

| | | | SO₂ Capacity dry | | SO₂ Capacity 70% RH | |
|---|---|---|---|---|---|---|
| | mmol amines/ | mmol carbonyls/ | Mol/kg | Mol/kg | Mol/ | Mol/ |
| Sample | g MCM-41 | g MCM-41 | sample | MCM-41 | kg sample | kg MCM-41 |
| MCM-41 | 0 | 0 | 0.03 | 0.03 | 0.03 | 0.03 |
| MAPS-MCM-41 | 0 | 2 | 0.14 | 0.18 | 0.09 | 0.11 |
| Urea-MCM-41 | 2 | 1 | 0.05 | 0.06 | 0.09 | 0.11 |
| isocyanate-MCM-41 | 2 | 2 | 0.06 | 0.09 | 0.11 | 0.16 |
| APTES-MCM-41 | 2 | 0 | 0.85 | 1.24 | 0.88 | 1.28 |
| Urea2x-MCM-41 | 4 | 2 | 0.08 | 0.12 | 0.17 | 0.24 |
| APTES-isoc.-MCM-41 | 4 | 2 | 0.63 | 1.23 | 0.60 | 1.16 |

The samples are listed in order of increasing amine content. In this system, SO₂ is much more difficult to remove than NH₃ since the parent MCM-41 has minimal sulfur dioxide capacity, so the capacities in this table are much lower than the corresponding ammonia capacities. Under dry conditions, the grafted APTES-MCM-41 has the highest sulfur dioxide capacity of 0.85 mol/kg sample, or 1.24 mol/kg MCM-41. When compared on a per silica basis, the APTESMCM-41 material shows a 41× increase compared to the parent MCM-41. Prehumidification at 70% RH in air does not influence the sulfur dioxide capacities compared to testing under dry conditions. The APTES-isocyanate-MCM-41 has a capacity of 1.23 mol/kg MCM-41, which is comparable to that of APTES-MCM-41. Consequently, all 2 mmol/g APTES on the APTES-isocyanate-MCM-41 sample is available for reaction with SO₂ and thus is not bound to the carbonyl active sites on the isocyanate molecules that are also present in this sample.

It is evident from the table that the carbonyl groups do not enhance SO₂ capacity. The shielding effect mentioned in the ammonia analysis is even more apparent for sulfur dioxide. In general, all grafted molecules that have a carbonyl group mask the effectiveness of the amine groups. This includes both urea- and isocyanate-grafted samples. The sulfur dioxide capacities for these materials are statistically similar to that of the parent MCM-41. As expected, grafting only carbonyl groups onto the siliceous support using MAPS does not increase the sulfur dioxide capacity above that of the parent.

The presence of amine groups within the grafted molecules provides sites for chemisorption of sulfur dioxide. In the presence of amines, sulfur dioxide can form 1:1 charge-transfer complexes, with electrons from nitrogen transferring to antibonding orbitals on the sulfur. [31] This complexation reaction provides the basis for chemisorption of sulfur dioxide onto the amine-grafted MCM-41 samples. The presence of carbonyl groups on the same grafted molecule with the amine groups reduces the efficiency of sulfur dioxide chemisorption by shielding the amines from interaction with SO₂. However, additional grafting of APTES onto the isocyanate-MCM-41 sample improves the sulfur dioxide capacity. Consequently, grafting different functional groups onto MCM-41 by using different molecules, rather than grafting one molecule with multiple functional groups, provides the ability to tailor adsorbent materials for removal of acidic and basic gases through grafting.

### Chemisorption Test

The reactions presented in the ammonia and sulfur dioxide adsorption sections involve bonding ammonia and sulfur dioxide to functional groups on the siliceous substrate. The capacities presented in the previous sections were single pass capacities; they were calculated by exposing the gas to regenerated, fresh adsorbent whose functional groups were available for reaction. To test for chemisorption, select samples were first analyzed for ammonia or sulfur dioxide capacity, purged with helium or air for 10 minutes while monitoring the amount of ammonia or sulfur dioxide desorbed, then re-tested for ammonia or sulfur dioxide capacity. In this way, it is possible to determine whether the adsorbed ammonia or sulfur dioxide is able to be removed from the system during the purging step. If the capacities of the purge step and the second breakthrough are low, then minimal light gas can be removed from the system, and a chemisorption reaction occurs between the functional groups and the light gas of interest. However, if large amounts of gas are removed during the purging step and the second breakthrough capacity is high, then the light gas is physisorbed onto the adsorbent.

FIG. 7 summarizes the ammonia capacities for the MAPS-MCM-41 sample. The first pass capacity is extremely high; 24 mol/kg sample. The 10 minute desorption step shows that approximately 1 mol/kg ammonia is desorbed from the sample. This is consistent with desorption of physisorbed ammonia throughout the MCM-41 support, since the parent MCM-41 has an ammonia capacity of 2 mol/kg, and most of that can be desorbed during the desorption step. The second breakthrough capacity, at 4.7 mol/kg sample, is five times lower than the first capacity. This is indicative of large amounts of chemisorption occurring on the sample during the first breakthrough test, as well as a smaller amount of physisorption.

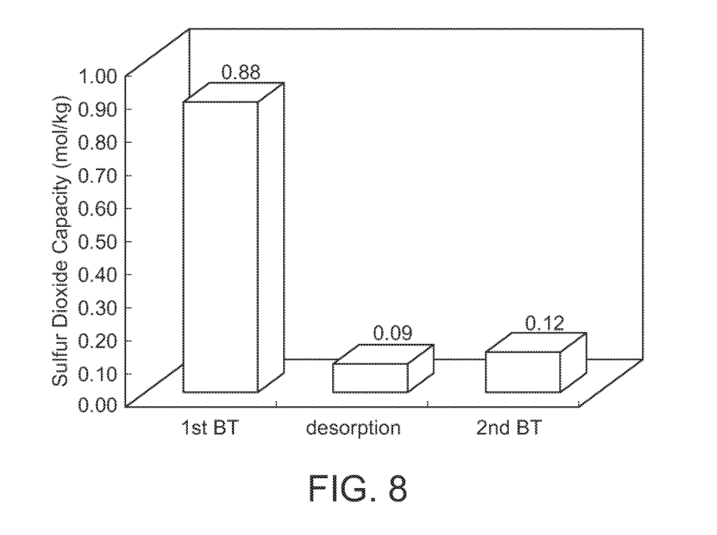

The sulfur dioxide capacities for APTES-MCM-41 are shown in FIG. 8. Based on the desorption capacity of 0.09 mol/kg, most of the adsorbed sulfur dioxide is chemisorbed on the adsorbent and is therefore not removed during the desorption step. The capacity calculated from the second breakthrough test is also small; 0.12 mol/kg, which is consistent with active amine sites being used up during reaction in the _rst breakthrough test. This type of materials is ideal for use as a respirator adsorbent or for other single-use applications, since it is beneficial to bind the toxic gas tightly to the adsorbent and not allow it to be easily desorbed.

### Grafted Zirconium Oxide Adsorbent

Zirconium hydroxide was grafted with 3-(triethoxysilyl)propyl isocyanate at a concentration of 2 mmol carbonyl groups/g Zr(OH)₄ is selected as an example to demonstrate the performance of the adsorbent toward ammonia and sulfur dioxide adsorption. This isocyanate molecule also provides one nitrogen (amine) functional group/g Zr(OH)₄. Table 1 summarizes the sulfur dioxide and ammonia capacities of this material compared to the ungrafted zirconium hydroxide.

TABLE 5
Ammonia and Sulfur Dioxide Capacities for
Grafted and Ungrafted Zirconium Hydroxide

| | NH₃ Capacity | SO₂ Capacity | SO₂ Capacity |
|---|---|---|---|
| | (mol/kg | (mol/kg | (mol/kg |
| Sample | sample) | sample) | Zr(OH)₄) |
| Zr(OH)₄ | 1.5 | 1.3 | 1.3 |
| Isocyanate - Zr(OH)₄ | 11.7 | 1.1 | 1.6 |

It is evident from the above data that grafting the isocyanate molecule enhances the ammonia capacity of the porous inorganic oxide material compared to that of the parent ungrafted zirconia. The sulfur dioxide capacity is lower for the grafted material, but this decrease in capacity is a result of calculating capacity per kg sample rather than per kg Zr(OH)₄. The parent Zr(OH)₄ has a capacity of 1.3 mol/kg sample, but that sample consists of 100% zirconium hydroxide. After grafting large molecules onto the zirconium hydroxide, the capacity is still reported in moles SO₂/kg sample, however the sample includes a mass of grafted molecules in addition to the Zr(OH)₄. The last column in Table 1 shows the sulfur dioxide capacity for the samples with units of mol SO₂/kg Zr(OH)₄. A comparison of the sulfur dioxide capacities of the grafted and parent zirconium hydroxide samples show that grafting the isocyanate molecule onto the inorganic oxide increases the capacity compared to the parent (1.6 vs. 1.3 mol/kg Zr(OH)₄). This capacity increase is due to the additional amine group imparted by the isocyanate molecule. Consequently, grafting carbonyl and amine groups in the form of isocyanate onto the zirconia support enhances the sulfur dioxide capacity when compared to the parent material on a mol SO₂/kg Zr(OH)₄ basis, and it also increases the ammonia capacity.

The toxic gas capacities of the grafted zirconia material are Much higher than the corresponding capacities of commercial adsorbent materials. Activated carbon has sulfur dioxide and ammonia capacities of 0.2 mol/kg and 0.1 mol/kg, respectively. Silica gel grade 633, which has 60 Å pores, has capacities of 0.3 mol/kg and 1.8 mol/kg, and zeolite 13× has capacities of 0.3 mol/kg and 1.5 mol/kg, respectively. Consequently, functionalizing these inorganic oxide substrates is able to greatly enhance toxic light gas adsorption. Furthermore, from a stoichiometric standpoint, if one ammonia molecule associates with one carbonyl group, then the zirconium hydroxide with grafted 3-(triethoxysilyl)propyl isocyanate should have a theoretical ammonia capacity of only 2.8 mol/kg sample. Thus, the capacity that we observe is much higher than what would be expected on the basis of stoichiometry, which is an unexpected result.

In the above experiments, a series of composite materials have been synthesized by taking advantage of silane chemistry to graft organoalkoxysilanes with unique functional groups onto a porous inorganic oxide material. By exploiting functional group chemistry, the biphasic materials exhibit high single pass capacities for sulfur dioxide, an acidic gas, and ammonia, a basic gas. The porous inorganic oxide material provides initial ammonia capacity. Organoalkoxysilane molecules containing carbonyl groups provide additional ammonia capacity, and molecules containing amine groups provide sulfur dioxide capacity.

A shielding effect can occur when both carbonyl and amine functional groups are present on the same grafted molecule. Urea-MCM-41 samples are dominated by the carbonyl groups on the urea and thus exhibit high ammonia capacities but low sulfur dioxide capacities, despite the fact that there are two amine groups per urea molecule. Similarly, isocyanate-MCM-41 has a higher ammonia capacity than urea since its carbonyl group is not surrounded by amine groups, as is urea. This sample also has a low sulfur dioxide capacity. The APTES molecule, which has no carbonyl functional group, imparts the highest sulfur dioxide capacity of all grafted molecules. Similarly, MAPS-MCM-41 has the highest ammonia capacity since it has only carbonyl and no amine groups.

Grafting two molecule types onto MCM-41 is one way to tailor the adsorbent for the removal of both gases. APTES-isocyanate-MCM-41 has a high sulfur dioxide capacity which is comparable to that of APTES-MCM-41. Although not as high as MAPS-MCM-41, the ammonia capacity of this sample is still extremely high. Both capacities are much higher than those of activated carbons. Grafting different amounts of these molecules onto MCM-41 provides the ability to tailor the resulting acidic and basic gas capacity for this bifunctional adsorbent material.

The foregoing description of the exemplary embodiments of the invention has been presented only for the purposes of illustration and description and is not intended to be exhaustive or to limit the invention to the precise forms disclosed. Many modifications and variations are possible in light of the above teaching.

While several and alternate embodiments of the present invention have been shown, it is to be understood that certain changes can be made as would be known to one skilled in the art without departing from the underlying scope of the invention as is discussed and set forth above and below including claims and drawings. Furthermore, the embodiments described above and claims set forth below are only intended to illustrate the principles of the present invention and are not intended to limit the scope of the invention to the disclosed elements.

While the foregoing specification teaches the principles of the present invention, with examples provided for the purpose of illustration, it will be appreciated by one skilled in the art from reading this disclosure that various changes in form and detail can be made without departing from the true scope of the invention.

### REFERENCES CITED

[1] C. T. Kresge, M. E. Leonowicz, W. J. Roth, J. C. Vartuli, J. S. Beck, Nature, 1992, 359, 710-712.
[2] M. Shengqian, L. Meng, Pure Appl. Chem., 2011, 83, 167-188.
[3] G. W. Peterson, G. W. Wgner, J. H. Keller, J. A. Rossin, Ind. Eng. Chem. Res., 2010, 49, 11182-11187.
[4] K. Tanabe, T. Yamaguchi, Catalysis Today, 1994, 20, 185-198.
[5] F. Hoffmann, M. Cornelius, J. Morell and M. Froba, Angew. Chem., Int. Ed., 2006, 45, 3216-3251.
[6] B. Marler, U. Oberhagemann, S. Vortmann, H. Gies, Microporous Mater., 1996, 6, 375-383.
[7] E. P. Plueddemann, G. L. Stark, Modern Plastics, 1974, 51, 74-84.
[8] N. R. E. N. Impens, P. van der Voort, E. F. Vansant, Microporous and Mesoporous Materials., 1999, 28, 217-232.
[9] N. Gartmann, D. Bruhwiler, Angew. Chem., Int. Ed., 2009, 48, 6354-6356.
[10] A. Walcarius, C. Delacote, Chem. Mater., 2003, 15, 4181-
[11] R. Richer, L. Mercier, Chem. Commun., 1998, 1775-.
[12] M. H. Lim, A. Sein, Chem. Mater., 1999, 11, 3285-.
[13] J. M. Rosenholm, M. Linden, Chem. Mater., 2007, 19, 5023-5034.
[14] J. M. Rosenholm, T. Czuryszkiewicz, F. Kleitz, J. B. Rosenholm, M. Linden, Langmuir, 2007, 23, 4315-.
[15] S. Yoo, J. D. Lunn, S. Gonzalez, J. A. Ristich, E. E. Simanek, D. F. Shantz, Chem. Mater., 2006, 18, 2935-2942.
[16] E. J. Acosta, C. S. Carr, E. E. Simanek, D. F. Shantz, Adv. Mater., 2004, 16, 985-989.
[17] I. Shimizu, A. Yoshino, H. Okabayashi, E. Nishio, C. O'Connor, J. Chem. Soc., Faraday Trans., 1997, 93, 1971-1979.
[18] B. Aziz, G. Zhao, N. Hedin, Langmuir, 2011, 27, 3822-3834.
[19] T. Borrego, M. Andrade, M. L. Pinto, A. R. Silva, A. P. Carvalho, J. Rocha, C. Freire, J. Pires, J. Colloid and Int. Sci., 2010, 344, 603-610.
[20] K. C. Vrancken, K. Possemeirs, P. Van Der Voort, E. F. Vansant, Colloids and Surfaces A: Physicochem. Eng. Aspects, 1995, 98, 235-241.
[21] J. A. Bae, K. C. Song, J. K. Jeon, Y. S. Ko, Y. K. Park, J. H. Yim, Microporous and Mesoporous Materials, 2009, 123, 289-297.
[22] F. Shang, H. Liu, J. Sun, B. Liu, C. Wang, J. Guan, Q. Kan, Catalysis Communications, 2011, 12, 739-743.
[23] T. Yokoi, H. Yoshitake, T. Tatsumi J. Mater. Chem., 2004, 14, 951-957.
[24] X. Wang, K. S. K. Lin, J. C. C. Chan, S. Cheng, J. Phys. Chem. B, 2005, 109, 1763-1769.
[25] D. Bruhwiler, Nanoscale, 2010, 2, 887-892.
[26] A. M. B. Furtado, Y. Wang, T. G. Glover, M. D. LeVan, Microporous Mesoporous Mater., 2011, 142, 730-739.
[27] B. A. Morrow, I. A. Cody, J. Phys. Chem., 1976, 80, 1998-2004.
[28] B. A. Morrow, I. A. Cody, L. S. M. Lee, J. Phys. Chem., 1975, 79, 2405-2408.
[29] S. Kittaka, M. Morimura, S. Ishimaru, A. Morino, K. Ueda, Langmuir, 2009, 25, 1718-1724.
[30] S. Parambadath, V. K. Rana, D. Zhao, C. Ha. Microporous Mesoporous Mater., 2011, 141, 94-101.
[31] F. Cotton, G. Wilkinson, C. Murillo, M. Bochmann, Advanced Inorganic Chemistry 6th ed. New York: John Wiley and Sons, Inc. 1999.
[32] T. W. G. Solomons, C. B. Fryhle, Organic Chemistry. New York: John Wiley and Sons, Inc. 2008.

What is claimed is:

1. An adsorbent material comprising:
a porous inorganic oxide material; and
a first molecule grafted to the porous inorganic oxide material;
wherein the first molecule comprises at least one carbonyl group.

2. The adsorbent material of claim 1, wherein the porous inorganic oxide material comprises Zr(OH)₄ or a porous silica material.

3. The adsorbent material of claim 2, wherein the porous inorganic oxide material comprises a porous silica material selected from the group consisting of SBA-15, MCM-48, and MCM-41; fumed silica; silicalite zeolites; and combinations thereof.

4. The adsorbent material of claim 1, further comprising a second molecule grafted to the porous inorganic oxide material, wherein the second molecule comprises an amine functional group.

5. The adsorbent material of claim 4, wherein the second molecule further comprises an alkoxysilane functional group.

6. The adsorbent material of claim 4, wherein the second molecule is 3-aminopropyltriethoxy silane or 3-aminopropyltrimethoxy silane.

7. The adsorbent material of claim 1, wherein the first molecule comprises an isocyanate group.

8. The adsorbent material of claim 1, wherein the first molecule comprises a urea group.

9. The adsorbent material of claim 1, wherein the first molecule further comprises an alkoxysilane functional group.

10. The adsorbent material of claim 1, wherein the first molecule is selected from the group consisting of methacryloxypropyl-trimethoxysilane, 3-trimethoxysilylpropyl urea and 3-triethoxysilylpropyl isocyanate.

11. The adsorbent material of claim 1, wherein the first molecule comprises a ketone group.

12. The adsorbent material of claim 1, wherein the first molecule further comprises at least one amine group.

13. The adsorbent material of claim 12, wherein the first molecule comprises a plurality of amine groups.

14. A method comprising:
contacting a porous inorganic oxide material with a first molecule comprising an alkoxysilane functional group and a carbonyl functional group;
allowing the alkoxysilane functional group to react with hydroxyl groups on the surface of the porous inorganic oxide material such that the first molecule is covalently attached to the porous inorganic oxide material.

15. The method of claim 14, wherein the porous inorganic oxide material comprises Zr(OH)₄ or a porous silica material.

16. The method of claim 14, wherein the inorganic oxide material is a porous silica material selected from the group consisting of: an ordered mesoporous silica material, SBA-15, MCM-48, MCM-41, fumed silica, silicalite zeolites, and combinations thereof.

17. The method of claim 14, further comprising calcining the porous inorganic oxide material prior to contacting the porous inorganic oxide material with the first molecule.

18. The method of claim 14, wherein the first molecule further comprises at least one amine group.

19. The method of claim 14, wherein the first molecule is selected from the group consisting of methacryloxypropyl-trimethoxysilane, 3-trimethoxysilylpropyl urea and 3-triethoxysilylpropyl isocyanate.

20. The method of claim 14, further comprising contacting the porous inorganic oxide material with a second molecule comprising an amine group.

21. The method of claim 14, wherein the first molecule comprises an isocyanate group, a urea group or a ketone group.

22. An adsorbent material made by the method of claim 14.

23. A method of removing molecules from a fluid containing the molecules, comprising:
contacting the fluid with the adsorbent material of claim 1 to allow the adsorbent material to adsorb the molecules from the fluid.

24. The method of claim 23, wherein the porous inorganic oxide material comprises a porous silica material or Zr(OH)₄.

25. The method of claim 23, wherein the fluid is a gas.

26. The method of claim 23, wherein the fluid is air.

27. The method of claim 26, wherein the air comprises water vapor.

28. The method of claim 23, wherein the fluid is air and the molecules are from toxic gases mixed with the air.

29. The method of claim 28, wherein the toxic gases are selected from the group consisting of sulfur dioxide, ammonia and combinations thereof.
